(19) United States
(12) Patent Application Publication
(10) Pub. No.: US 2022/0373094 A1
(43) Pub. Date: Nov. 24, 2022

(54) PRESSURE RESISTANCE VALVE STRUCTURE

(71) Applicant: Wen-Jeng LIN, Taichung City (TW)

(72) Inventor: Wen-Jeng LIN, Taichung City (TW)

(21) Appl. No.: 17/695,171

(22) Filed: Mar. 15, 2022

(30) Foreign Application Priority Data
May 20, 2021 (TW) 110118278

(51) Int. Cl. F16K 15/06; F16K 27/02; F16K 1/36

(52) U.S. Cl. CPC F16K 15/06; F16K 27/02; F16K 1/36; F16K 5/08

(57) ABSTRACT

The present invention relates to a pressure resistance valve structure, which comprises a front valve seat body, a pressure resistance valve core body and a rear valve seat body. The pressure resistance valve core body is closed or released from the closed state relative to the front valve seat body, to control the export of liquid or gaseous fluids. The overall composition of the present invention is simple in structure, reducing the risk of component failure after long-term use, so as to achieve the effect of structural stability and good convenience of use.

### FIELD

The present invention relates to a pressure resistance valve structure and, in particular, a control valve structure applied to liquid or gaseous fluids, which belongs to relevant technical field.

### BACKGROUND

The structure of a conventional water stop joint is shown in FIG. 11. The water stop joint 60 is provided with an inlet pipe 61, a fixed seat 62, and a shaft core member 63 an elastic member 64 and a driving ring 65. The inlet pipe 61 is provided with a water inlet portion 610 and a water outlet portion 611, and the water outlet portion 611 has an outlet 611A, and a water channel 620 is formed through the fixing seat 62, and the shaft core member 63 and the elastic member 64 are accommodated in the water outlet portion 611. One side of the elastic piece 64 is against the inner wall of the water outlet portion 611, and the other side of the elastic piece 64 is against the shaft core member 63, and the fixed seat 62 is fixed in the end side of the water outlet portion 611, and the driving ring 65 accommodates set in the water channel 620 of the fixed seat 62, a faucet 66 is locked into or out of the outlet 611A of the inlet pipe 61, and the faucet 66 drives the shaft core 63 to conduct or close the interior of the inlet pipe 61. When replacing the faucet 66, the faucet 66 is directly withdrawn from the inlet pipe 61, and the shaft core member blocks the water in the inlet pipe 61 to prevent leakage. The faucet 66 pushes against and drives the shaft core member 63, so that the shaft core member 63 conducts the fluid introduction pipe 61, and then makes the water flow out from the faucet 66. Although it can achieve the function of stopping the water after the faucet 66 is disassembled, its overall composition is complex. And if the number of components is large, there will be the risk of damage, failure and maintenance, so it is necessary to improve.

### SUMMARY OF THE DISCLOSURE

In view of the problems of complex structure and poor structural stability of the joint structure of the water stopper, the present invention completes the pressure resistance valve structure of the present invention.

One of the aspect of the present invention is to provide a pressure resistance valve structure. The pressure resistance valve structure comprises: a front valve seat body, the front valve seat body is provided with a lead-out port, a front inner sliding space and a pair of joint openings, the joint opening is provided with a ring flange, the lead-out opening is provided with a front locking thread, and the inner diameter of the front inner sliding space is A; a pressure resistance valve core body, the pressure resistance valve core body is provided with a pressure resistance cover and a, the pressure resistance cover is integrally provided at one end of the hollow valve core body, the connection between the pressure resistance valve core body and hollow valve core body is provided with at least notch part, the notch part is connected with the inside of the hollow valve core body, the outer diameter of the pressure resistance cover is B, the outer diameter of the hollow valve core body is C, the outer diameter B of the pressure bearing cover is larger than the outer diameter C of the hollow valve core body, and the outer diameter B of the pressure bearing cover is larger than the inner diameter A of the front inner sliding space set by the front valve seat body, and the outer diameter C of the hollow valve core body is smaller than the inner diameter A of the front inner sliding space, wherein the hollow valve core body is slidably displaced and accommodated in the front inner sliding space set by the front valve seat body; and a rear valve seat body, wherein the rear valve seat body is provided with an inlet, a rear inner sliding space and a fitting opening, a rear locking thread is arranged in the inlet, the inner diameter of the rear inner sliding space is D, the inner diameter D of the rear inner sliding space is larger than the outer diameter B of the pressure bearing cover set by the pressure bearing valve core body, the rear inner sliding space is provided for the pressure bearing resistance set by the pressure bearing valve core body, cover is slidably displaced, and the outer diameter B of the pressure resistance cover is smaller than the inner diameter D of the rear inner sliding space, so that there is a distance between the edge of the pressure resistance cover and the inner wall of the rear inner sliding space, wherein the fitting opening sleeved and fixed on the ring flange of the abutment opening set on the front valve seat body.

In a preferred embodiment, the pressure resistance valve core body and the pressure resistance cover and the hollow valve core body are connected with the notch part, which is arranged in the form of two notch parts opposite to each other, increasing the efficiency of the present invention.

In a preferred embodiment, the pressure resistance valve core body's pressure resistance cover and the hollow valve core body are connected with the notch part, which is set at three equal points of the three notch parts, increasing the efficiency of the present invention.

In a preferred embodiment, the inner side of the ring flange of the abutment opening of the front valve seat body is provided with a ring inclined surface, and the pressure resistance cover of the pressure resistance valve core body is provided with an opposite inclined ring edge, and the pressure resistance cover is affected by the fluid pressure, when the inclined ring edge is attached to the ring slope, the overall water-tightness or airtightness is increased. The inner end face of the hollow valve core body is in the shape of a concave arc, which improves the smoothness of fluid guiding and increases the multiple practicability of the present invention.

By connecting the introduction port of the rear valve seat body with a fluid introduction pipe, the fluid introduction pipe is provided with a locking external thread, and the locking external thread is locked with the rear locking thread set at the introduction port, and the fluid or gas is in liquid or gas state. The fluid is introduced into the inner sliding space behind the rear valve seat body, and the introduced fluid pushes the pressure against the pressure abutment cover set on the valve core body, so that the pressure abutment cover abuts against the ring flange set on the opposite opening of the front valve seat body, and the introduced fluid is sealed and accumulated in the rear inner sliding space set by the rear valve seat body, and the outlet of the front valve seat body is connected with a lead-out tool, which is a faucet or a pneumatic tool, and the lead-out tool is provided with a locking thread is locked with the front locking thread provided in the lead-out port, and the lead-out tool is combined with the lead-out port of the front valve seat body. The valve core body makes the closed pressure against the pressure of the valve core body against the cover, and separates from the ring flange set on the butt opening of the front valve seat body, so that the fluid presses against the hollow valve core body of the valve core body by pressure. The notch part is introduced into the hollow spool and then exported by the export tool. The overall structure is simple, reducing the risk of component failure after long-term use, effectively reducing production and use costs, and can be used in various fields to achieve structural stability. The effect of good convenience can be achieved.

### BRIEF DESCRIPTION OF THE DRAWINGS

FIG. 1 is a schematic diagram of the three-dimensional combination and partial cross-sectional state of the pressure resistance valve structure of the present invention.

FIG. 2 is a schematic diagram of the three-dimensional exploded state of the pressure resistance valve structure of the present invention.

FIG. 3 is a side view sectional state reference diagram of the pressure resistance valve structure of the present invention.

FIG. 4 is a side view sectional view of the fluid action state reference diagram of the pressure resistance valve structure of the present invention.

FIG. 5 is a reference diagram of the pressure resistance valve structure of the present invention used in a faucet.

FIG. 6 is a reference diagram of the pressure resistance valve structure of the present invention used in a pneumatic tool.

FIG. 7 is a reference diagram of the first embodiment of the pressure resistance valve structure of the present invention. The hollow valve core body of the pressure resistance valve core body is provided with two sets of oppositely arranged notch parts.

FIG. 8 is a reference diagram of the second embodiment of the pressure resistance valve structure of the present invention. The hollow valve core body of the pressure resistance valve core body is arranged in three groups of equal parts.

FIG. 9 is the third embodiment of the pressure resistance valve structure of the present invention, the ring slope in the ring flange set at the abutment opening of the front valve seat body and the inclined ring set on the pressure resistance cover of the pressure resistance valve core body When the pressure abutting cover is under the action of fluid pressure, the inclined ring edge is pressed against the inclined surface of the ring and is in the state of abutting and tight contact. Refer to the drawing.

FIG. 10 is a reference diagram of the state where several elastic steel ball clamps are installed inside the lead-out port of the front valve seat body of the third embodiment of the pressure resistance valve structure of the present invention.

FIG. 11 is a reference diagram of the joint structure of the conventional water stopper of the pressure resistance valve structure of the present invention.

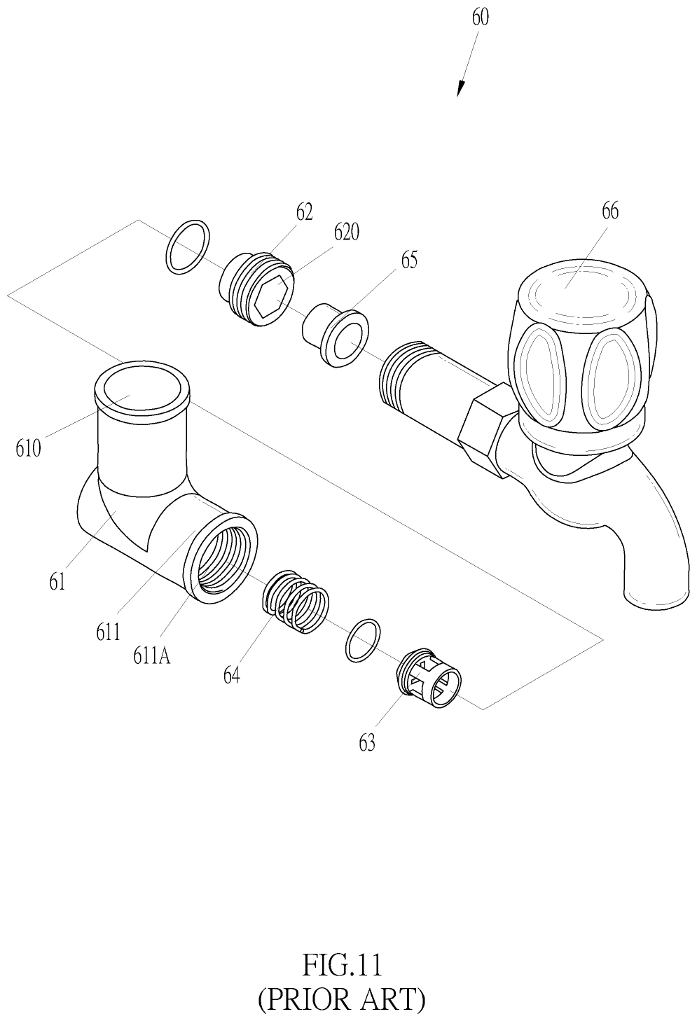

### DETAILED DESCRIPTION

In order to have the Examiner to further understand the structure, features and other purposes of the present invention, the following preferred embodiments are attached with drawings for detailed descriptions as follows. However, the embodiments described in the drawings are for illustrative purposes. It is not the only restriction for the purpose of the present patent application.

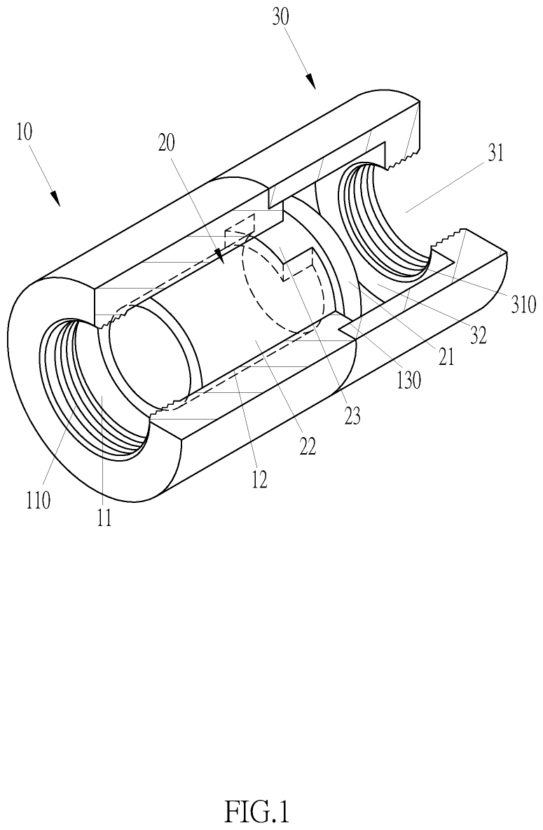

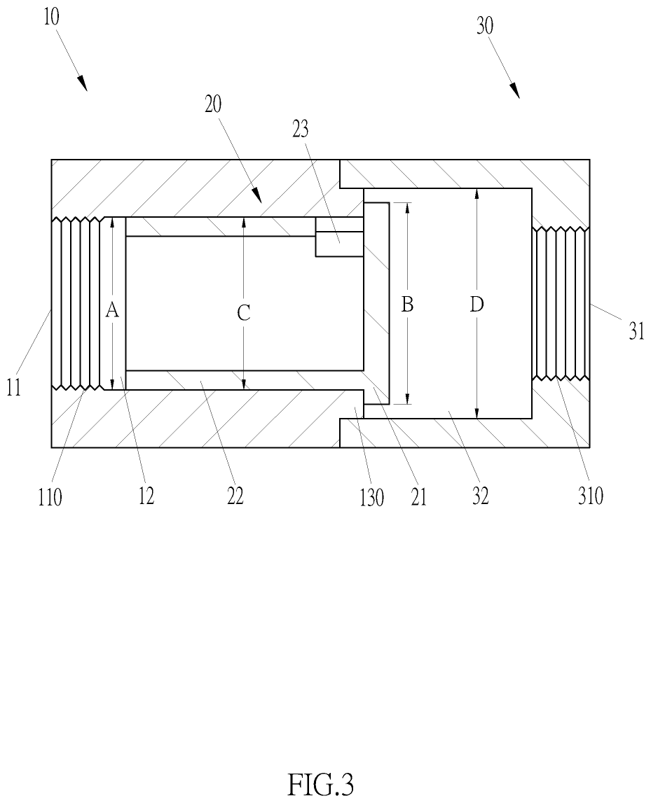

Reference is made to FIGS. 1-3, which are reference diagrams of the three-dimensional assembly, partial cross-sectional state, three-dimensional exploded state, and side-view cross-sectional state of the pressure resistance valve structure of the present invention, including:

A front valve seat body 10, the front valve seat body 10 is provided with a lead-out port 11, a front inner sliding space 12 and a pair of closing openings 13. The closing opening 13 is provided with a ring flange 130, a front locking thread 110 is arranged in the lead-out port 11, and the inner diameter of the front inner sliding space 12 is A.

A pressure resistance valve core body 20, the pressure resistance valve core body 20 is provided with a pressure resistance cover 21 and a hollow valve core body 22, the pressure resistance cover 21 is integrally provided at one end of the hollow valve core body 22, at least one notch portion 23 is formed at the connection between the pressure resistance cover 21 and the hollow valve body 22 , the notch portion 23 is connected to the inside of the hollow valve body 22 , the outer diameter of the pressure resistance cover 21 is B, the outer diameter of the hollow valve core body 22 is C, the outer diameter B of the pressure resistance cover 21 is larger than the outer diameter C of the hollow valve core body 22, the outer diameter B of the pressure resistance cover 21 is larger than the inner diameter A of the front inner sliding space 12 set by the seat body 10, and the outer diameter C of the hollow valve core body 22 is smaller than the inner diameter A of the front inner sliding space 12 set by the front valve seat body 10, wherein the hollow valve core body 22 is accommodated in the front inner sliding space 12 of the front valve seat body 10 in a slidable displacement manner; and

A rear valve seat body 30, the rear valve seat body 30 is provided with an inlet 31, a rear inner sliding space 32 and a fitting opening 33, the inlet 31 is provided with a rear locking thread 310, the rear inner The inner diameter of the sliding space 32 is D, and the inner diameter D of the rear inner sliding space 32 is greater than the outer diameter B of the pressure resistance valve body 20 against the cover 21. The abutting cover 21 is accommodated in the rear inner sliding space 32 in a slidable displacement manner. The outer diameter B of the pressing cover 21 is smaller than the inner diameter D of the rear inner sliding space 32, so that the pressing force resisting the edge of the cover 21 and the rear inner sliding. The inner wall of the space 32 is spaced apart, the sleeve opening 33 is sleeved and fixed to the ring flange 130 of the opening 13 of the front valve seat body 10, and the rear valve seat body 30 and the front valve seat body 10 are sleeved together. It is then fixed by welding.

Through the cooperation of the above structures, the pressure resistance valve structure of the present invention is completed.

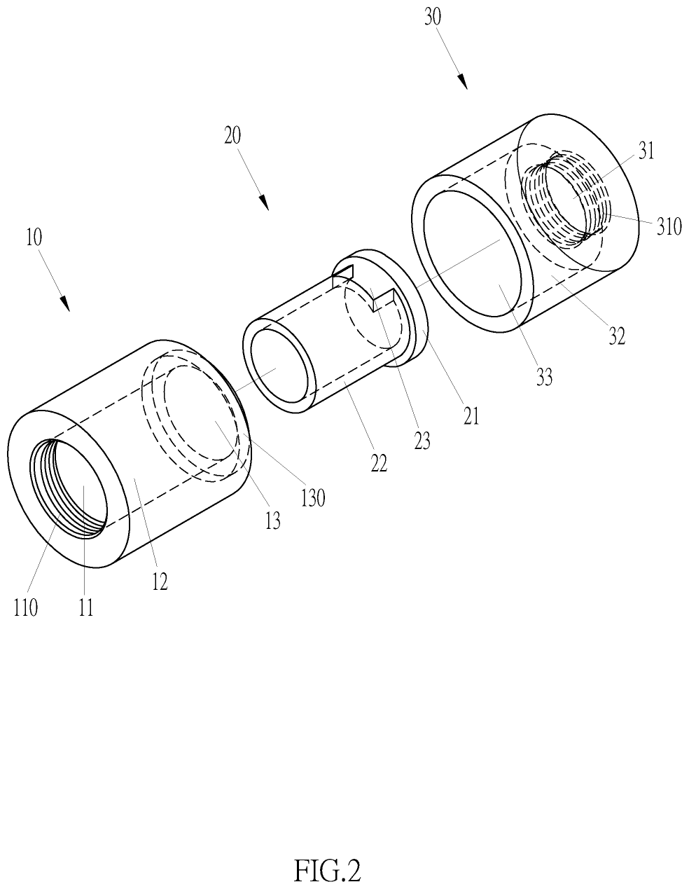

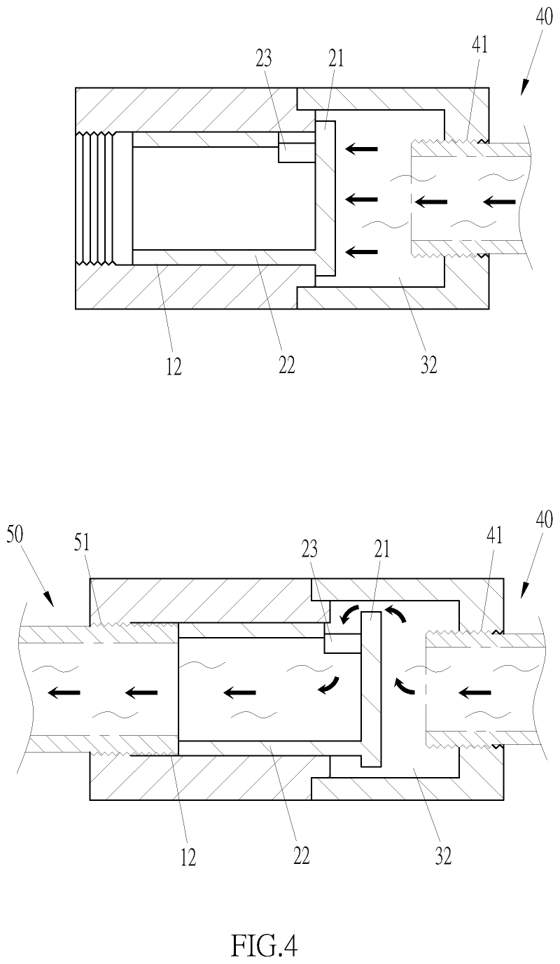

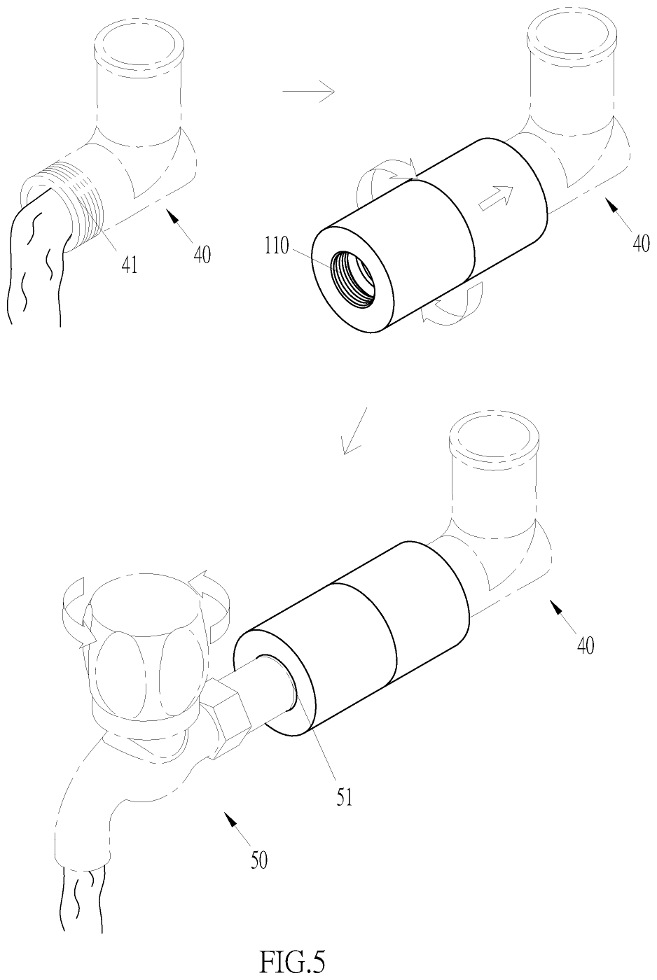

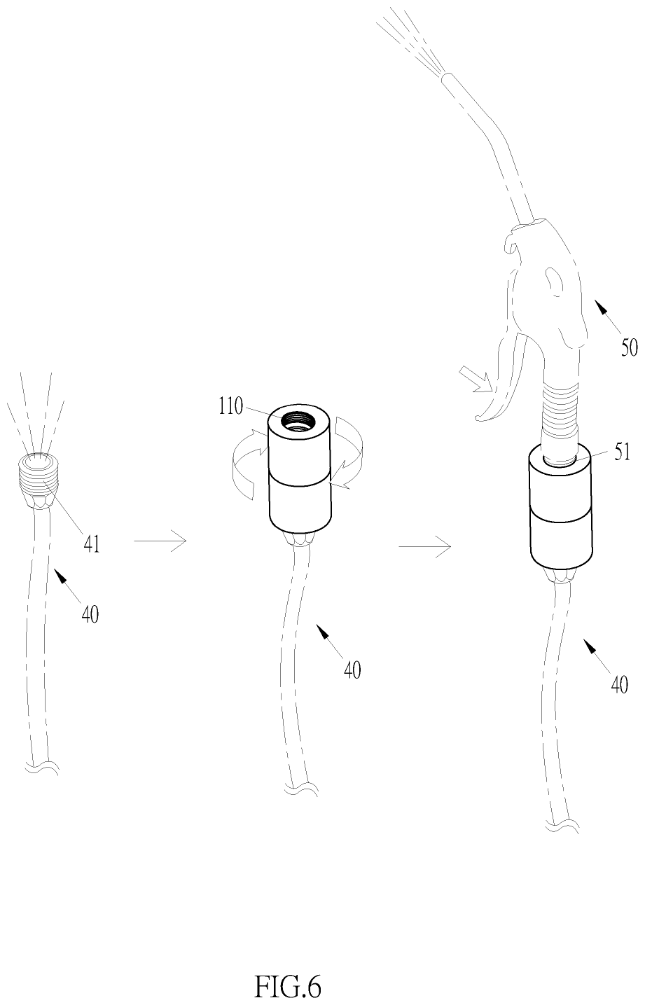

Reference is made to FIGS. 2 to 6, which are the three-dimensional exploded state, the side-view section state, the side-view section fluid action state, the state of being used in a faucet, and the state of being used in a pneumatic tool of the present invention. The hollow valve core body 22 of the valve core body 20 is slidably displaced and accommodated in the front inner sliding space 12 provided by the front valve seat body 10. It is accommodated in the rear inner sliding space 32 provided by the rear valve seat body 30, and the outer diameter B of the pressure resistance cover 21 is smaller than the inner diameter D of the rear inner sliding space 32 provided by the rear valve seat body 30, so that there is a distance between the edge and the inner wall of the rear inner sliding space 32 provided on the rear valve seat body 30, and the ring flange 130 of the matching opening 13 provided on the front valve seat body 10 is sleeved and fixed on the rear valve seat body 30. The opening 33 is sleeved together, and the front valve seat body 10 and the rear valve seat body 30 are fixed by welding after being sleeved together. The pipe 40 is provided with a locking external thread 41, and the locking external thread 41 is locked with the rear locking thread 310 provided by the inlet 31. The sliding space 32 is inside the valve seat body 30 after the liquid or gaseous fluid is introduced into the inlet. The fluid pushes the pressure against the valve core body 20 against the pressure against the cover 21, so that the pressure against the cover 21 abuts against the ring flange 130 provided in the opposite opening 13 of the front valve seat body 10, and the introduced fluid is sealed and accumulated. In the rear inner sliding space 32 of the rear valve seat body 30. In addition, the lead-out port 11 of the front valve seat body 10 is connected to a lead-out tool 50. The lead-out tool 50 is a faucet or a pneumatic tool, and the lead-out tool 50 is provided with a locking thread 51, and the locking thread 51 is connected to the lead-out port 11. The provided front locking screw 110 is combined with the lead-out port 11 of the front valve seat body 10 on the lead-out tool 50 , and the lead-out tool 50 pushes back against the pressure against the hollow valve body 22 of the valve core body 20, so that the closed pressure presses against the pressure of the valve core body 20 and presses the cover 21, and separates from the ring flange 130 provided on the butt opening 13 of the front valve seat body 10, so that the fluid presses against the hollow valve core of the valve core body 20 by pressure. The notch portion 23 set on the body 22 is introduced into the hollow valve core body 22 and then exported by the export tool 50. The overall structure is simple, which reduces the risk of failure of components used for a long time, effectively reduces production and use costs, and can be used in various fields, in order to achieve the effect of structural stability and convenience of use.

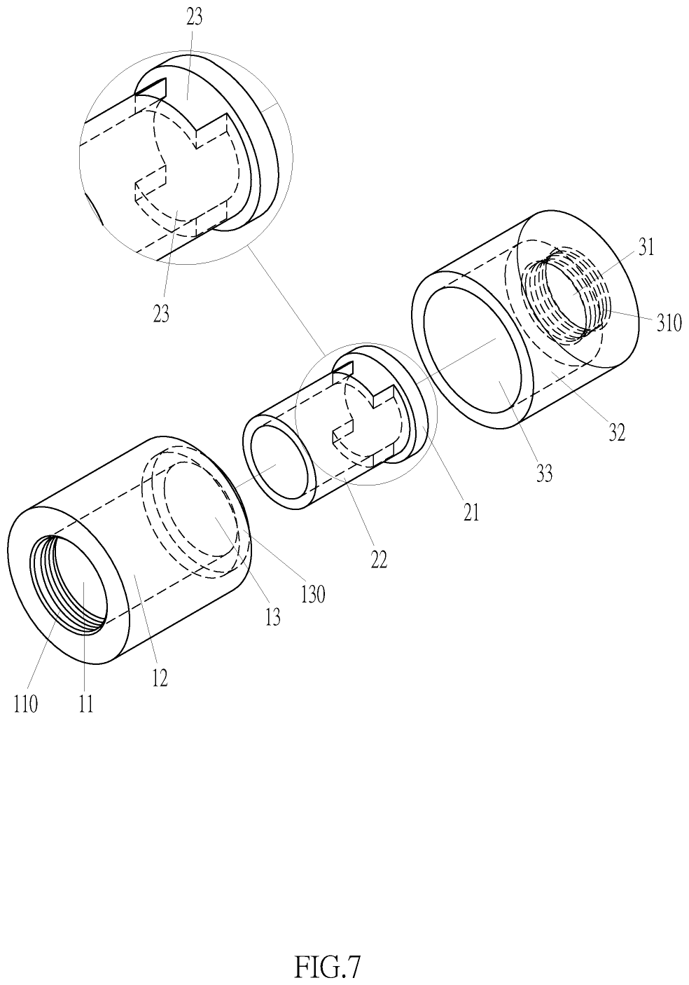

Reference is next made to FIG. 7, which is a reference diagram of the first embodiment of the pressure resistance valve structure of the present invention. The hollow valve core body of the pressure resistance valve core body is provided with two sets of oppositely arranged notch parts. The overall structure is the same as that of the present invention. Invention of FIGS. 1 to 6 are the same, except that the pressure against the pressure of the valve core body 20 is against the pressure of the cover 21 and the hollow valve core body 22. Or the efficiency of gas outlet to increase the multiple practicality of the present invention.

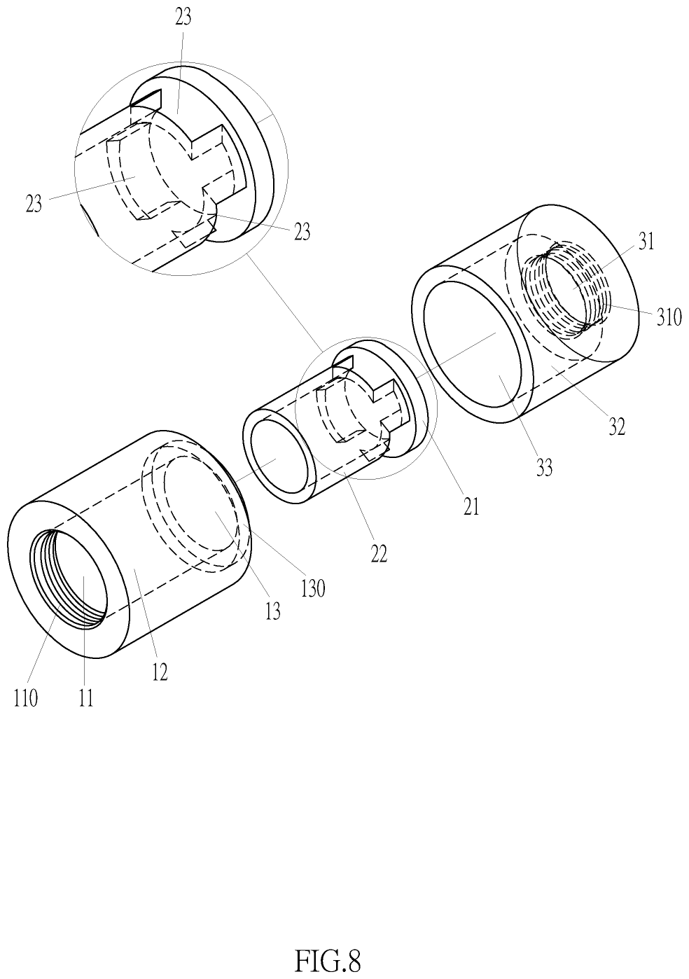

Reference is next made to FIG. 8, which is a reference diagram of the second embodiment of the pressure resistance valve structure of the present invention. The overall structure is the same as that of FIGS. 1 to 6 of the present invention, except that the pressure resistance valve core body 20 is pressed against the pressure resistance cover 21 and the hollow valve core body 22. The equal parts are arranged to increase the overall water or gas output efficiency, so as to increase the multiple practicability of the present invention

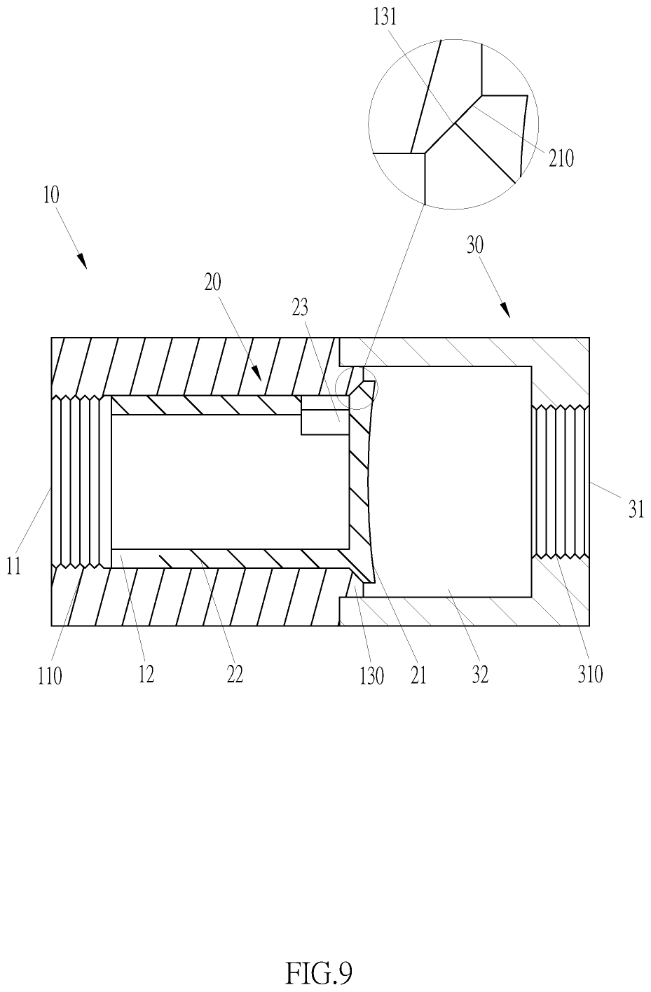

Reference is made to FIG. 9, which is the third embodiment of the pressure resistance valve structure of the present invention. The inner side of the lead-out port of the front valve seat body and the front inner sliding space are provided with an inner ring slope and the pressure resistance cover is in a tight contact state. Referring to the drawings, the overall structure is the same as that of FIGS. 1 to 6 of the present invention, except that the inner side of the ring flange 130 of the abutting opening 13 of the front valve seat body 10 is provided with a ring slope 131, and the pressure resists the pressure of the valve core body 20. The abutting cover 21 is provided with an opposite inclined ring edge 210. When the pressure resistance cover 21 is subjected to the action of fluid pressure, the inclined ring edge 210 abuts against the ring inclined surface 131 to increase the overall watertightness or airtightness, thereby increasing the multiplicity of the present invention practicality.

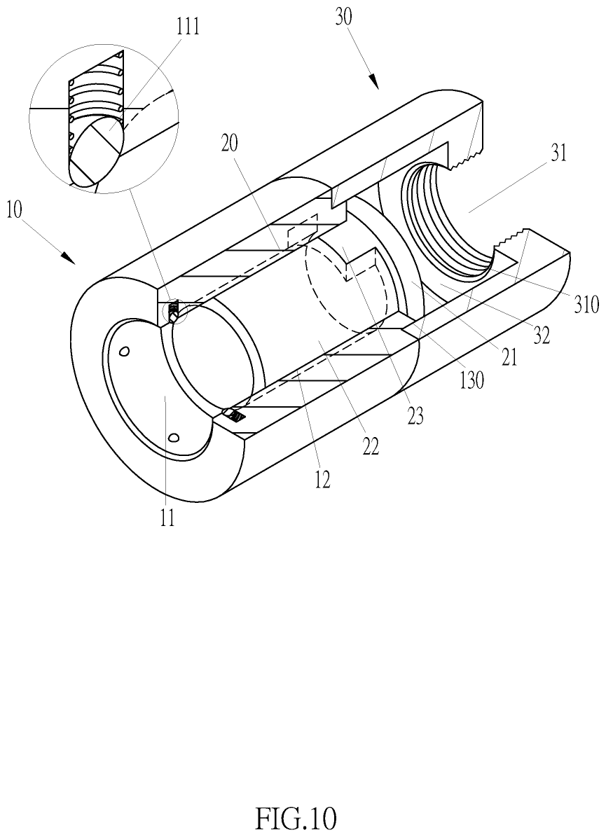

Reference is then made to FIG. 10, which is a reference diagram of the state where several elastic steel ball clamping pieces are arranged inside the lead-out port of the front valve seat body of the third embodiment of the pressure resistance valve structure of the present invention, and its overall structure is the same as the diagram of the present invention. FIGS. 1 to 6 are the same, except that the inner side of the lead-out port 11 of the front valve seat body 10 is provided with several elastic steel ball clamping parts 111. The elastic steel ball clamping parts 111 can be quickly clamped together with the pneumatic tool handle (not shown in the figure), to increase the multiple utility of the present invention

In sum, the present invention can indeed achieve the above-mentioned functions and purposes. Therefore, the present invention should meet the requirements of a patent application, and an application should be filed in accordance with the law.

1. A pressure resistance valve structure, comprising:
a front valve seat body, the front valve seat body is provided with a lead-out port, a front inner sliding space and a pair of joint openings, the joint opening is provided with a ring flange, the lead-out opening is provided with a front locking thread, and the inner diameter of the front inner sliding space is A;
a pressure resistance valve core body, the pressure resistance valve core body is provided with a pressure resistance cover and a, the pressure resistance cover is integrally provided at one end of the hollow valve core body, the connection between the pressure resistance valve core body and hollow valve core body is provided with at least notch part, the notch part is connected with the inside of the hollow valve core body, the outer diameter of the pressure resistance cover is B, the outer diameter of the hollow valve core body is C, the outer diameter B of the pressure bearing cover is larger than the outer diameter C of the hollow valve core body, and the outer diameter B of the pressure bearing cover is larger than the inner diameter A of the front inner sliding space set by the front valve seat body, and the outer diameter C of the hollow valve core body is smaller than the inner diameter A of the front inner sliding space, wherein the hollow valve core body is slidably displaced and accommodated in the front inner sliding space set by the front valve seat body; and
a rear valve seat body, wherein the rear valve seat body is provided with an inlet, a rear inner sliding space and a fitting opening, a rear locking thread is arranged in the inlet, the inner diameter of the rear inner sliding space is D, the inner diameter D of the rear inner sliding space is larger than the outer diameter B of the pressure bearing cover set by the pressure bearing valve core body, the rear inner sliding space is provided for the pressure bearing resistance set by the pressure bearing valve core body, cover is slidably displaced, and the outer diameter B of the pressure resistance cover is smaller than the inner diameter D of the rear inner sliding space, so that there is a distance between the edge of the pressure resistance cover and the inner wall of the rear inner sliding space, wherein the fitting opening sleeved and fixed on the ring flange of the abutment opening set on the front valve seat body.

2. The pressure resistance valve structure as claim 1, wherein the front valve seat body and the rear valve seat body are assembled and fixed by welding.

3. The pressure resistance valve structure as claim 1, wherein the pressure resistance valve core body and the pressure resistance cover and the hollow valve core body are connected with the notch part, which is arranged in the form of two notch parts opposite to each other.

4. The pressure resistance valve structure as claim 1, wherein the pressure resistance valve core body's pressure resistance cover and the hollow valve core body are connected with the notch part, which is set at three equal points of the three notch parts.

5. The pressure resistance valve structure as claim 1, wherein the inner side of the ring flange of the abutment opening of the front valve seat body is provided with a ring inclined surface, and the pressure resistance cover of the pressure resistance valve core body is provided with an opposite inclined ring edge, and the pressure resistance cover is affected by the fluid pressure, when the inclined ring edge is attached to the ring slope, the overall water-tightness or airtightness is increased.

6. The pressure resistance valve structure as claim 1, wherein the introduction port of the rear valve seat body is further connected with a fluid introduction pipe, the fluid introduction pipe is provided with a locking external thread, the locking external thread is locked with the rear locking thread provided in the introduction port, and is suitable for liquid or gaseous fluids, introduced into the sliding space behind the rear valve seat body, the introduced fluid pushes the pressure against the pressure abutment cover set on the valve core body so that the pressure abutment cover abuts against the ring flange set at the butt opening of the front valve seat body, and the introduced fluid is sealed and accumulated in the rear inner sliding space provided by the rear valve seat body.

7. The pressure resistance valve structure as claim 1, wherein the lead-out port of the front valve seat body is further connected with a lead-out tool, and the lead-out tool is provided with a locking thread, the locking thread is locked with the front locking thread provided in the lead-out port, the lead-out tool is combined with the front valve seat the lead-out port of the body, the end of the lead-out tool pushes the pressure back against the hollow valve body of the valve core body so that the airtight pressure presses against the pressure of the valve core body against the cover, the abutment of the valve seat body is separated from the front seat body, the ring flange set at the opening makes the fluid press against the notch part of the hollow valve core body by the pressure, and is led into the hollow valve core body and then led out by the exporting tool.

8. The pressure resistance valve structure as claim 7, wherein the export tool is a faucet or a pneumatic tool.

9. The pressure resistance valve structure as claim 1, wherein the front locking thread set on the inner side of the lead-out port of the front valve seat body is replaced with a number of elastic steel ball clamping parts.
